(19) United States
(12) Patent Application Publication
(10) Pub. No.: US 2025/0376608 A1
(43) Pub. Date: Dec. 11, 2025

(54) ADHESIVE COMPOSITION AND ADHESIVE SHEET FORMED THEREFROM

(71) Applicant: DONGWOO FINE-CHEM CO., LTD., Jeollabuk-do (KR)

(72) Inventors: HYE RIM KWON, Jeollabuk-do (KR); GEON SHIN, Jeollabuk-do (KR); KYOUNG MOON JUNG, Jeollabuk-do (KR); IN OH HWANG, Jeollabuk-do (KR)

(21) Appl. No.: 19/310,088

(22) Filed: Aug. 26, 2025

Related U.S. Application Data
(63) Continuation of application No. PCT/KR2024/002612, filed on Feb. 28, 2024.

(30) Foreign Application Priority Data
Feb. 28, 2023 (KR) 10-2023-0027109

(51) Int. Cl. C09J 133/10; C09J 11/06

(52) U.S. Cl. CPC C09J 133/10; C09J 11/06

(57) ABSTRACT

An adhesive composition includes an acryl-based copolymer, an organometallic compound and an isocyanate compound. The acryl-based copolymer may include a polymer of a monomer blend comprising 80 to 97 wt % of an alkyl(meth)acrylate monomer having an alkyl group having a carbon number of 8 or greater, and 3 to 20 wt % of a polar monomer, and 3 wt % or less of an acid group-containing polar monomer. This adhesive sheet including an adhesive layer can provide excellent recovery rate, adhesive force, and folding properties.

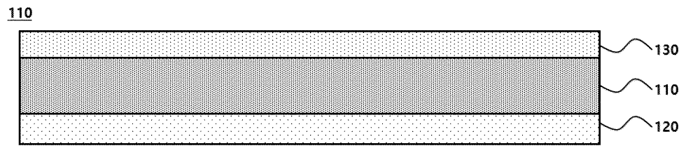

### CROSS-REFERENCE TO RELATED APPLICATION AND CLAIM OF PRIORITY

The present application is a continuation application to International Application No. PCT/KR2024/002612 with an International Filing Date of Feb. 28, 2024, which claims the benefit of Korean Patent Application No. 10-2023-0027109 filed on Feb. 28, 2023 at the Korean Intellectual Property Office, the disclosures of which are incorporated by reference herein in their entirety.

### BACKGROUND

### 1. Field

The present invention relates to an adhesive composition and an adhesive sheet formed therefrom. More particularly, the present invention relates to an adhesive composition including an acryl-based copolymer and an adhesive sheet formed therefrom.

### 2. Description of the Related Art

Recently, various information processing functions have been combined with an image display device such as a smartphone in which a communication function is combined. Accordingly, structures such as a touch panel and an antenna may be included together with an optical layer (e.g., a polarizing plate, a retardation plate, etc.) for an image implementation in one image display device.

Thus, an adhesive layer or an adhesive sheet is used to laminate the above-described optical layer and structures on a display panel. For example, an adhesive sheet may be used to attach the antenna or the touch panel onto the display panel.

A display having improved reliability is required even under harsh conditions of high temperature and humidity or external physical impact, and thus formation of the structure coupled to the display for preventing detachment and peel-off despite the external impact and harsh conditions is required. Thus, an adhesive or an adhesive sheet for combining the display structures while having improved adhesion and durability is required.

Additionally, as a flexible display that can be folded or bent have recently been developed, the adhesive layer or the adhesive sheet applied to the image display device also needs to be designed to have improved flexibility.

### SUMMARY

An object of the present invention is to provide an adhesive composition capable of forming an adhesive layer that has improved elasticity and recovery ratio.

An objective of the present invention is to provide an adhesive sheet having improved elasticity and recovery ratio.

1. An adhesive composition, including: an acrylic copolymer including a polymer of a monomer blend that includes 80 to 97 wt % of an alkyl (meth)acrylate monomer having an alkyl group having 8 or more carbon atoms, 3 to 20 wt % of a hydroxyl group-containing polar monomer, and 3 wt % or less of an acid group-containing polar monomer; an organometallic compound; and an isocyanate compound.

2. The adhesive composition according to the above 1, wherein the hydroxyl group-containing polar monomer includes at least one of 2-hydroxyethyl (meth)acrylate, 2-hydroxypropyl (meth)acrylate, 4-hydroxybutyl (meth)acrylate, 2-hydroxybutyl (meth)acrylate, and hydroxyhexyl (meth)acrylate.

3. The adhesive composition according to the above 1, wherein the acid group-containing polar monomer includes at least one of (meth)acrylic acid, carboxyethyl (meth)acrylate, and carboxypentyl (meth)acrylate.

4. The adhesive composition according to the above 1, wherein the organometallic compound includes a metal chelate compound including at least one metal atom of titanium, zirconium, aluminum, zinc, iron and tin.

5. The adhesive composition according to the above 1, wherein a content of the organometallic compound is in a range from 0.1 to 2.0 parts by weight based on 100 parts by weight of the acrylic copolymer.

6. The adhesive composition according to the above 1, wherein the isocyanate compound is a polyfunctional isocyanate compound having two or more functional groups.

7. The adhesive composition according to the above 1, wherein a content of the isocyanate compound is 0.001 to 0.5 parts by weight based on 100 parts by weight of the acrylic copolymer.

8. The adhesive composition according to the above 7, wherein the content of the isocyanate compound is 0.001 parts by weight or more, and less than 0.05 parts by weight based on 100 parts by weight of the acrylic copolymer.

9. The adhesive composition according to the above 1, wherein the adhesive composition further includes a cross-linking retarder.

10. The adhesive composition according to the above 9, wherein a content of the cross-linking retarder is in a range from 0.1 to 1.5 parts by weight based on 100 parts by weight of the acrylic copolymer.

11. An adhesive sheet including an adhesive layer that includes a cured product of the adhesive composition according to the above 1.

12. The adhesive sheet according to the above 11, wherein a recovery ratio defined by Equation 1 of the adhesive layer is 80% or more:

$$recovery ratio ( \% ) = ( 1 - \frac{A}{B} ) \times 100 \qquad [ Equation l ]$$

(In Equation 1, A is a creep strain measured after applying a shear stress of 10,000 Pa at 25° C. to a laminate in which 20 of the adhesive layers each having a thickness of 50 μm are stacked and maintaining for 600 seconds, and

B is a recovery strain measured after 600 seconds after removing the shear stress).

13. The adhesive sheet according to the above 12, wherein the recovery ratio of the adhesive layer is 85% or more.

An adhesive composition according to embodiments of the present invention may include an acrylic copolymer, an organometallic compound, and an isocyanate compound. Accordingly, an adhesive layer having improved adhesion and adhesion durability may be provided from the adhesive composition.

In example embodiments, the acrylic copolymer may include an alkyl(meth)acrylate monomer that includes an alkyl group having 8 or more carbon atoms, and a monomer containing a hydroxy group together. Accordingly, flexibility and bending properties of the acrylic copolymer may be improved, and an adhesive strength to a structure may be improved.

Thus, the adhesive composition may be applied to adhesion of various structures of a flexible device, and stable adhesion durability and flexibility can be maintained even in repetitive folding/bending operations.

An adhesive sheet according to example embodiments may be formed from the above-described adhesive composition. In some embodiments, the adhesive sheet may have a low elastic modulus at low temperature. Accordingly, the adhesive sheet has improved adhesive properties, and may have stable flexibility and flexural durability when applied to the flexible device. Additionally, the adhesive sheet may have an improved recovery ratio.

### BRIEF DESCRIPTION OF THE DRAWING

FIGURE is a schematic cross-sectional view illustrating an adhesive sheet in accordance with example embodiments.

### DETAILED DESCRIPTION OF THE EMBODIMENTS

An adhesive composition according to embodiments of the present invention may include an acrylic copolymer, an organometallic compound and an isocyanate compound.

Additionally, the adhesive sheet according to embodiments of the present invention may include an adhesive layer including a cured product of the adhesive composition.

Hereinafter, embodiments of the present invention will be described in detail.

### <Adhesive Composition>

The adhesive composition according to embodiments may include an acrylic copolymer, an organometallic compound, and an isocyanate compound.

The acrylic copolymer may be prepared from a monomer blend or a monomer syrup in which a plurality of types of monomers are mixed.

The monomer blend may include an alkyl(meth)acrylate monomer and a polar monomer. For example, the acrylic copolymer may include a polymer of the monomer blend including the alkyl(meth)acrylate monomer and the polar monomer.

The alkyl(meth)acrylate monomer may be a (meth)acrylate monomer having an alkyl group with 8 or more carbon atoms. The acrylic copolymer may be formed from the (meth)acrylate monomer that includes the alkyl group having 8 or more carbon atoms, so that flexibility of the copolymer may be improved, and brittleness may be reduced, thereby improving mechanical and folding properties of the adhesive layer.

Additionally, the (meth)acrylate monomer having the relatively large carbon number and a long molecular length may be used, so that polarization properties of the adhesive layer may be reduced. Accordingly, a dielectric constant of the adhesive layer may be lowered while reducing a dielectric tangent, so that signal disturbance and interference by the adhesive layer may be prevented when the adhesive layer is applied to, e.g., an antenna or a touch panel.

For example, examples of the alkyl(meth)acrylate monomer having an alkyl group with 8 or more carbon atoms may include lauryl (meth)acrylate, stearyl (meth)acrylate, 2-ethylhexyl (meth)acrylate, 2-ethylhexyl diglycol acrylate, 2-decyl-1-tetradecanyl (meth)acrylate, 2-dodecyl-1-hexadecanyl (meth)acrylate, n-octyl (meth)acrylate, isooctyl (meth)acrylate, isobornyl acrylate, n-nonyl (meth)acrylate, isononyl (meth)acrylate, n-decyl (meth)acrylate, isodecyl (meth)acrylate, n-dodecyl (meth)acrylate, and stearyl (meth)acrylate. The alkyl(meth)acrylate monomer having an alkyl group with 8 or more carbon atoms may be used alone or in a combination of two or more thereof.

Preferably, at least one of lauryl (meth)acrylate, stearyl (meth)acrylate, 2-ethylhexyl (meth)acrylate, 2-ethylhexyl diglycol acrylate, 2-decyl-1-tetradecanyl (meth)acrylate, 2-dodecyl-1-hexadecanyl (meth)acrylate, isodecyl (meth)acrylate and n-dodecyl (meth)acrylate, more preferably at least one of lauryl (meth)acrylate, stearyl (meth)acrylate, 2-ethylhexyl (meth)acrylate and 2-ethylhexyl diglycol acrylate may be used as the alkyl(meth)acrylate monomer having an alkyl group with 8 or more carbon atoms.

The term “(meth)acryl-” used in this application is used to encompass both “acryl-” and “methacryl-”.

In some embodiments, a content of the alkyl(meth)acrylate monomer may be 80 to 97 wt % of the total weight of the monomer blend, and preferably 80 to 90 wt %.

When the content of the alkyl(meth)acrylate monomer is less than 80 wt %, the content of a hydroxyl group-containing polar monomer and an acid group-containing polar monomer may be increased, and a cohesive force of the acrylic copolymer may become excessively high. Accordingly, an elasticity modulus may be increased and folding properties may be lowered.

When the content of the alkyl(meth)acrylate monomer exceeds 97 wt %, the content of the hydroxyl group-containing polar monomer and the acid group-containing polar monomer may be decreased, and cohesiveness of the acrylic copolymer may be lowered. Accordingly, adhesiveness and durability may be decreased.

The polar monomer may be a polymerizable monomer that may be copolymerized with the alkyl(meth)acrylate monomer and contains a polar functional group. Cohesiveness of the acrylic copolymer may be further enhanced by the polar monomer, and mechanical stability of the adhesive layer may be improved when being folded.

Additionally, the polar functional group of the polar monomer may form a coordination bond with the organometallic compound as will be described below. Thus, a degree of curing and cohesiveness of the adhesive composition may be improved, and durability of the adhesive layer formed from the adhesive composition may be enhanced.

In example embodiments, the polar monomer may contain a hydroxyl group as the polar functional group. For example, the polar monomer may include the hydroxyl group-containing polar monomer. The hydroxyl group-containing polar monomer may easily form a coordination bond or an ionic bond with the organometallic compound in the adhesive layer by an unshared electron pair of the hydroxyl group. Thus, a low elastic modulus of the adhesive layer may be maintained at low temperature, and an adhesive strength may be enhanced.

For example, 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 2-hydroxyethylene glycol (meth)acrylate, 12-hydroxylauryl (meth)acrylate, (4-hydroxymethylcyclohexyl)methyl acrylate, 2-hydroxypropylene glycol (meth)acrylate, hydroxyalkylene glycol (meth)acrylate having 2-4 carbon atoms in an alkylene group, 4-hydroxybutyl vinyl ether, 5-hydroxypentyl vinyl ether, 6-hydroxyhexyl vinyl ether, 7-hydroxyheptyl vinyl ether, 8-hydroxyoctyl vinyl ether, 9-hydroxynonyl vinyl ether, 10-hydroxydecyl vinyl ether, etc., may be used as the hydroxyl group-containing monomers. The hydroxyl group-containing monomers may be used alone or in a combination of two or more therefrom.

Preferably, at least one of 2-hydroxyethyl (meth)acrylate, 2-hydroxypropyl (meth)acrylate, 4-hydroxybutyl (meth)acrylate, 2-hydroxybutyl (meth)acrylate, and hydroxyhexyl (meth)acrylate may be used as the hydroxyl group-containing monomer. More preferably at least one of 2-hydroxyethyl (meth)acrylate, 4-hydroxybutyl (meth)acrylate, and 2-hydroxybutyl (meth)acrylate may be used as the hydroxyl group-containing monomer. Accordingly, bending durability and adhesion of the adhesive layer may be further improved.

In some embodiments, a content of the hydroxyl group-containing polar monomer may be in a range from 3 to 20 wt % based on the total weight of the monomer blend, and preferably from 5 to 15 wt %. When the content of the hydroxyl group-containing polar monomer is less than 3 wt % based on the total weight of the monomer blend, cohesiveness of the acrylic copolymer may be lowered. When the content of the hydroxyl group-containing polar monomer exceeds 20 wt % based on the total weight of the monomer blend, cohesiveness of the acrylic copolymer may be excessively increased, and a restoring force may be lowered.

In some embodiments, the polar monomer may further include the acid group-containing polar monomer. In this case, cohesiveness of the acrylic copolymer may be improved, and adhesiveness and bending durability of the adhesive layer may be further enhanced.

For example, the acid group-containing polar monomer may be a carboxyl group-containing monomer. The carboxyl group-containing monomer may be (meth)acrylic acid, carboxyethyl (meth)acrylate, carboxypentyl (meth)acrylate, crotonic acid, isocrotonic acid, maleic acid, itaconic acid, fumaric acid, etc. The acid-containing polar monomer may be used alone or in combination of two or more therefrom.

Preferably, the carboxyl group-containing monomer may include at least one of (meth)acrylic acid, carboxyethyl (meth)acrylate and carboxypentyl (meth)acrylate, more preferably (meth)acrylic acid may be used.

In some embodiments, when the monomer blend includes the acid group-containing polar monomer, a content of the acid group-containing polar monomer may be 3 wt % or less based on the total weight of the monomer blend. For example, the content of the acid group-containing polar monomer may be more than 0 wt %, and 3 wt % or less, preferably more than 0 wt % and 1.5 wt % or less based on the total weight of the monomer blend.

When the content of the acid group-containing polar monomer exceeds 3 wt % based on the total weight of the monomer blend, time-dependent stability of the adhesive composition may be degraded due to the acid group (e.g., the carboxyl group). Additionally, cohesive force of the acrylic copolymer and mechanical stability of the adhesive layer while being folded may be lowered.

For example, the acrylic copolymer may be prepared by a method such as a bulk polymerization, a solution polymerization, an emulsion polymerization, or a suspension polymerization, and preferably may be prepared by the solution polymerization. Additionally, a solvent, a polymerization initiator, a chain transfer agent for controlling a molecular weight, etc., that may be commonly used during polymerization may be used.

In some embodiments, the acrylic copolymer may have a weight average molecular weight (polystyrene conversion, Mw) measured by a gel permeation chromatography (GPC) of 50,000 to 2,000,000 g/mol. Preferably, the weight average molecular weight of the acrylic copolymer may be in a range from 500,000 to 1,500,000 g/mol. Within the above range, even without using a large amount of diluted solvent, a coating process feasibility may be obtained, and durability degradation due to lack of cohesion may be prevented.

In example embodiments, the adhesive composition may include the organometallic compound.

The organometallic compound may improve the adhesion of the adhesive layer to the surface of an adhesion object. For example, the organometallic compound may form a coordination bond or an ionic bond on the surface of the adhesion object, and an adhesive force of the adhesive layer to the adhesion object may be increased flexibly according to adhesion conditions.

For example, the acrylic copolymer may form a chemical bond with the adhesive object when being cured, so that the adhesive force of the adhesive layer may not be increased beyond a predetermined value within a predetermined elastic modulus range. The organometallic compound may form the ionic bond or the coordination bond with the surface of the adhesive object, so that the adhesive force of the adhesive layer may be further enhanced according to changes of the adhesion conditions even when the adhesive composition is cured.

Additionally, a metal atom of the organometallic compound may form a coordination bond with a polar functional group of the acrylic copolymer, such as a hydroxyl group or a carboxyl group, so that cohesive force and mechanical stability of the adhesive layer may be further improved. Further, the organometallic compound may form a coordination bond or an ionic bond with respect to, e.g., a corona-treated or plasma-treated surface of an object, so that the adhesive layer may have improved adhesion.

In some embodiments, the organometallic compound may include a metal atom such as titanium, zirconium, aluminum, zinc, iron and tin. Preferably, the organometallic compound may include at least one metal atom of titanium, zirconium, and aluminum. For example, the organometallic compound may include an organotitanium compound, an organozirconium compound, an organoaluminum compound, etc. The organometallic compounds may be used alone or in a combination of two or more therefrom.

In some embodiments, the organometallic compound may have at least one organic functional group, e.g., a polymerizable functional group. In this case, the organometallic compound may form a cross-linking network through heating or a photo-reaction, so that the cohesiveness and cross-linking property of the adhesive composition may be improved.

In an embodiment, the organometallic compound may include a metal chelate compound containing at least one of the above-described metal atoms. For example, the metal chelate compound may be a complex compound formed by combining at least one organic functional group with a metal or a metal oxide.

Examples of the organotitanium compound containing titanium may include tetraethoxy titanium, tetra-n-propoxy titanium, tetra-i-propoxy titanium, tetra-n-butoxy titanium, tetra-n-butoxy titanium dimer, tetra-i-butoxy titanium, tetra-sec-butoxy titanium, tetra-t-butoxy titanium, titanium di-2-ethylhexyloxy bis(2-ethyl-3-hydroxyhexyloxide), titanium lactate, a titanium lactate ammonium salt, titanium diisopropoxy bis(triethanolaminate), tetrakis(2-ethylhexyloxy)titanium, titanium-i-propoxyoctylene glycolate, di-i-propoxy bis(acetylacetonate)titanium, propanedioxy titanium bis(ethylacetoacetate), tri-n-butoxy titanium monostearate, di-i-propoxy titanium distearate, titanium stearate, di-i-propoxy titanium diisostearate, (2-n-butoxycarbonylbenzoyloxy)tributoxy titanium, di-n-butoxybis(triethanolaminato)titanium, triethoxymono(acetylacetonate)titanium, tri-n-propoxymono(acetylacetonate)titanium, tri-i-propoxymono(acetylacetonate)titanium, tri-n-butoxymono(acetylacetonate)titanium, tri-sec-butoxymono(acetylacetonate)titanium, tri-t-butoxymono(acetylacetonate)titanium, diethoxybis(acetylacetonate)titanium, di-n-propoxybis(acetylacetonate)titanium, di-n-butoxybis(acetylacetonate)titanium, di-sec-butoxybis(acetylacetonate)titanium, di-t-butoxybis(acetylacetonate)titanium, monoethoxytris(acetylacetonate)titanium, mono-n-propoxytris(acetylacetonate)titanium, mono-i-propoxytris(acetylacetonate)titanium, mono-n-butoxytris(acetylacetonate)titanium, mono-sec-butoxytris(acetylacetonate)titanium, mono-t-butoxytris(acetylacetonate)titanium, tetrakis(acetylacetonate)titanium, triethoxymono(ethylacetoacetate)titanium, tri-n-propoxymono(ethylacetoacetate)titanium, tri-i-propoxymono(ethylacetoacetate)titanium, tri-n-butoxymono(ethylacetoacetate)titanium, tri-sec-butoxymono(ethylacetoacetate)titanium, tri-t-butoxymono(ethylacetoacetate)titanium, diethoxybis(ethylacetoacetate)titanium, di-n-propoxybis(ethylacetoacetate)titanium, di-i-propoxybis(ethylacetoacetate)titanium, di-n-butoxybis(ethylacetoacetate)titanium, di-sec-butoxybis(ethylacetoacetate)titanium, di-t-butoxybis(ethylacetoacetate)titanium, monoethoxytris(ethylacetoacetate)titanium, mono-n-propoxytris(ethylacetoacetate)titanium, mono-i-propoxytris(ethylacetoacetate)titanium, mono-n-butoxytris(ethylacetoacetate)titanium, mono-sec-butoxytris(ethylacetoacetate)titanium, mono-t-butoxytris(ethylacetoacetate)titanium, tetrakis(ethylacetoacetate)titanium, mono(acetylacetonate)tris(ethylacetoacetate)titanium, bis(acetylacetonate)bis(ethylacetoacetate)titanium, and tris(acetylacetonate) mono(ethylacetoacetate)titanium. The organotitanium compound containing titanium may be used alone or in a combination of two or more therefrom.

Examples of the organozirconium compounds containing zirconium may include a zirconium alkoxide such as tetraethoxyzirconium, tetra-n-propoxyzirconium, tetra-i-propoxyzirconium, tetra-n-butoxyzirconium (normal butylzirconate), tetra-i-butoxyzirconium, tetra-sec-butoxyzirconium, tetra-t-butoxyzirconium; diisopropoxyzirconium bisacetylacetonate, triethoxymono(acetylacetonate)zirconium, tri-n-propoxymono(acetylacetonate)zirconium, tri-i-propoxymono(acetylacetonate)zirconium, tri-n-butoxymono(acetylacetonate)zirconium, tri-sec-butoxymono(acetylacetonate)zirconium, tri-t-butoxymono(acetylacetonate)zirconium, diethoxybis(acetylacetonate)zirconium, di-n-propoxybis(acetylacetonate)zirconium, di-i-propoxybis(acetylacetonate)zirconium, di-n-butoxybis(acetylacetonate)zirconium, di-sec-di-t-butoxybis(acetylacetonate)zirconium, butoxybis(acetylacetonate)zirconium, monoethoxytris(acetylacetonate)zirconium, mono-n-propoxytris(acetylacetonate)zirconium, mono-i-propoxytris(acetylacetonate)zirconium, mono-n-butoxytris(acetylacetonate)zirconium, mono-sec-butoxytris(acetylacetonate)zirconium, mono-t-butoxytris(acetylacetonate)zirconium, tetrakis(acetylacetonate)zirconium, triethoxymono(ethylacetoacetate)zirconium, tri-n-propoxymono(ethylacetoacetate)zirconium, tri-i-propoxymono(ethylacetoacetato)zirconium, tri-n-butoxymono(ethylacetoacetato)zirconium, tri-sec-butoxymono(ethylacetoacetato)zirconium, tri-t-butoxymono(ethylacetoacetato)zirconium, diethoxybis(ethylacetoacetato)zirconium, di-n-propoxybis(ethylacetoacetato)zirconium, di-i-propoxybis(ethylacetoacetato)zirconium, di-n-butoxybis(ethylacetoacetato)zirconium, di-sec-butoxybis(ethylacetoacetato)zirconium, di-t-butoxybis(ethylacetoacetato)zirconium, monoethoxytris(ethylacetoacetato)zirconium, mono-n-propoxytris(ethylacetoacetato)zirconium, mono-i-propoxytris(ethylacetoacetato)zirconium, mono-n-butoxytris(ethylacetoacetato)zirconium, mono-sec-butoxytris(ethylacetoacetato)zirconium, mono-t-butoxytris(ethylacetoacetato)zirconium, tetrakis(ethylacetoacetato)zirconium, mono(acetylacetonate)tris(ethylacetoacetato)zirconium, bis(acetylacetonate)bis(ethylacetoacetato)zirconium, and tris(acetylacetonate) mono(ethylacetoacetato)zirconium, etc. The organozirconium compound containing zirconium may be used alone or in a combination of two or more therefrom.

Examples of the organoaluminum compound containing aluminum may include diisopropoxy aluminum monooleyl acetoacetate, monoisopropoxy aluminum bisoleyl acetoacetate, monoisopropoxy aluminum monooleate monoethyl acetoacetate, diisopropoxy aluminum monolauryl acetoacetate, diisopropoxy aluminum monostearyl acetoacetate, diisopropoxy aluminum monoisostearyl acetoacetate, isopropoxy aluminum bis acetylacetonate, monoisopropoxy aluminum mono-N-lauroyl-β-alanate monolauryl acetoacetate, aluminum tris acetylacetonate, aluminum monoacetylacetonate bis(isobutylacetonate) chelate, aluminum monoacetylacetonate bis(2-ethylhexyl acetoacetate) chelate, aluminum monoacetylacetonate bis(dodecylacetoacetate) chelate, and aluminum monoacetylacetonate bis(oleyl acetoacetate) chelate, etc. The organoaluminum compound containing aluminum may be used alone or in a combination of two or more therefrom.

Preferably, at least one of tetraethoxytitanium, tetra-n-propoxytitanium, tetraethoxyzirconium, diisopropoxyzirconium bisacetylacetonate, isopropoxyaluminum bisacetylacetonate, and diisopropoxyaluminum monostearylacetoacetate can be used as the organometallic compound, more preferably at least one of diisopropoxyzirconium bisacetylacetonate, isopropoxyaluminum bisacetylacetonate, and diisopropoxyaluminum monostearylacetoacetate may be used. Accordingly, cohesiveness and cross-linking properties of the adhesive composition may be further improved.

In some embodiments, the organometallic compound may be included in an amount from 0.01 to 2.5 parts by weight based on 100 parts by weight of the acrylic copolymer. In the above range, the organometallic compound may improve cohesion and adhesion without causing contamination of the adhesion object.

Preferably, the content of the organometallic compound may be in a range from 0.1 to 2.0 parts by weight based on 100 parts by weight of the acrylic copolymer. In the above range, the adhesive layer may have a low elastic modulus at low-temperature, and adhesion to the adhesion object may be further improved.

In example embodiments, may include the isocyanate compound.

The isocyanate compound may function as a thermal cross-linking agent for the acrylic copolymer. Additionally, when the isocyanate compound is included, a degree of cross-linking of the adhesive composition may be increased, thereby improving a recovery ratio of the adhesive layer. For example, the adhesive layer including the adhesive composition that may include the isocyanate compound may have a high recovery ratio, thereby improving folding properties.

In some embodiments, the isocyanate compound may be a multi-functional isocyanate compound having two or more functional groups.

For example, the isocyanate compound may include a diisocyanate-based compound such as tolylene diisocyanate, xylene diisocyanate, hexamethylene diisocyanate, 2,4-diphenylmethane diisocyanate, 4,4-diphenylmethane diisocyanate, isophorone diisocyanate, tetramethylxylene diisocyanate, etc.; an adduct obtained by reacting 3 mol of a diisocyanate compound with 1 mol of a polyhydric alcohol compound such as trimethylolpropane, an isocyanurate obtained by self-condensing 3 mol of a diisocyanate compound, a biuret produced by condensing diisocyanate urea obtained from 2 mol of 3 mol of diisocyanate compound with remaining 1 mol of diisocyanate, a polyfunctional isocyanate compound containing three functional groups such as triphenylmethane triisocyanate, methylene bis triisocyanate, etc. The isocyanate compound may be used alone or in a combination of two or more therefrom.

Preferably, the adduct in which 3 mol of the diisocyanate compound is reacted with 1 mol of the polyhydric alcohol compound such as trimethylolpropane may be used. Accordingly, folding properties of the adhesive layer may be further improved.

In some embodiments, the isocyanate compound may be included in an amount of 0.001 to 0.5 parts by weight, 0.001 to 0.3 parts by weight, or 0.01 to 0.1 parts by weight based on 100 parts by weight of the acrylic copolymer. In the above range, the recovery ratio of the adhesive layer may be improved without decreasing an adhesive strength.

Preferably, the isocyanate compound may be included in an amount of 0.001 to 0.04 parts by weight, 0.005 to 0.04 parts by weight, or 0.01 to 0.04 parts by weight based on 100 parts by weight of the acrylic copolymer. More preferably, the isocyanate compound may be included in an amount of 0.01 to 0.035 parts by weight, 0.01 to 0.03 parts by weight, or 0.015 to 0.03 parts by weight based on 100 parts by weight of the acrylic copolymer. In the above range, the isocyanate compound may appropriately crosslink the acrylic copolymer, thereby improving the recovery ratio of the adhesive layer and further improving the folding properties.

In some embodiments, the adhesive composition may further include a cross-linking retarder. The cross-linking retarder may provide a curing time to the adhesive composition, thereby inhibiting a rapid curing of the adhesive composition. Additionally, a viscosity of the adhesive composition may be controlled by including the cross-linking retarder.

For example, the cross-linking retarder may include β-ketoester such as acetylacetone, acetic acid, methyl acetoacetate, ethyl acetoacetate, octyl acetoacetate, oleyl acetoacetate, lauryl acetoacetate, stearyl acetoacetate, etc., 2,4-hexanedione, benzoylacetone, etc. The cross-linking retarder may be used alone or in a combination of two or more therefrom, preferably, acetylacetone may be used as the cross-linking retarder.

In some embodiments, the cross-linking retarder may be included in an amount of 0.1 to 1.5 parts by weight, preferably 0.1 to 1.0 parts by weight, based on 100 parts by weight of the acrylic copolymer. In the above range, the adhesive composition may maintain a viscosity at which the adhesive composition may not be completely cured.

In some embodiments, the adhesive composition may further include a photo-polymerization initiator for improving cross-linking properties.

Examples of the photo-polymerization initiator may include, e.g., benzoin, benzoin methyl ether, benzoin ethyl ether, benzoin isopropyl ether, benzoin-n-butyl ether, benzoin isobutyl ether, acetophenone, 1-hydroxycyclohexyl-1-phenylmethanone, hydroxydimethylacetophenone, dimethylaminoacetophenone, dimethoxy-2-phenylacetophenone, 3-methylacetophenone, 2,2-dimethoxy-2-phenylacetophenone, 2,2-diethoxy-2-phenylacetophenone, 4-chloroacetophenone, 4,4-dimethoxyacetophenone, 2-hydroxy-2-methyl-1-phenylpropan-1-one, 4-hydroxycyclophenyl ketone, 1-hydroxycyclohexylphenyl ketone, 2-methyl-1-[4-(methylthio)phenyl]-2-morpholino-propan-1-one, oligo [2-hydroxy-2-methyl-1-(4-(1-methylvinyl)phenyl) propanone], 4-(2-hydroxyethoxy)phenyl-2-(hydroxy-2-propyl) ketone, benzophenone, p-phenylbenzophenone, 4,4-diaminobenzophenone, 4,4′-diethylaminobenzophenone, dichlorobenzophenone, anthraquinone, 2-methylanthraquinone, 2-ethylanthraquinone, 2-t-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyldimethylketal, diphenyl ketone benzyl dimethyl ketal, acetophenone dimethyl ketal, p-dimethylaminobenzoic acid ester, 2,4,6-trimethylbenzoyl diphenyl phosphine oxide (TPO), fluorene, triphenylamine, carbazole, azobisisobutyronitrile (AIBN), etc. The photo-polymerization initiator may be used alone or in a combination of two or more therefrom.

In some embodiments, a content of the photo-polymerization initiator may be in a range from 0.01 to 3 parts by weight, preferably from 0.2 to 2 parts by weight, based on 100 parts by weight of the acrylic copolymer.

In some embodiments, the adhesive composition may further contain an additive such as an antioxidant, a corrosion inhibitor, a leveling agent, a surface lubricant, an antifoaming agent, a filler, a plasticizer, a light stabilizer, a reaction initiator, a solvent, etc., within a range that does not degrade the adhesion and folding properties of the acrylic copolymer and the organometallic compound as described above.

### <Adhesive Sheet>

FIGURE is a schematic cross-sectional view illustrating an adhesive sheet according to example embodiments.

Referring to FIGURE, the adhesive sheet 100 may include an adhesive layer 110. In an embodiment, the adhesive sheet 100 may further include a protective film formed on at least one surface of the adhesive layer 110. The adhesive layer 110 may include a cured product of the adhesive composition as described above.

In example embodiments, a recovery ratio of the adhesive layer 110 defined by Equation 1 may be 80% or more.

$$recovery ratio ( \% ) = ( 1 - \frac{A}{B} ) \times 100 \qquad [ Equation l ]$$

In Equation 1, A is a creep strain measured after applying a shear stress of 10,000 Pa at 25° C. to a laminate in which 20 of the adhesive layers each having a thickness of 50 μm are stacked and maintaining for 600 seconds, B is a recovery strain measured after 600 seconds after removing the shear stress.

Within the above range, folding and bending properties may be improved, and stable adhesive durability and flexibility may be maintained during repetitive folding or bending even when being applied adhesion of various structures of a flexible device.

For example, cracks or detachment may not occur in the adhesive layer 100 even in 20,000 or more bendings at a speed of 25 times per minute with a radius of curvature of 2 mm at −30° C.

Preferably, the recovery ratio defined by Equation 1 may be 85% or more. In the above range, folding and bending properties may be further improved.

In some embodiments, a storage modulus of the adhesive layer 110 at −20° C. may be 150 kPa or less. The adhesive layer 110 may a low storage modulus at −20° C., so that the adhesive layer 110 may have a high elastic property and flexibility, and mechanical properties of the adhesive layer 110 may be improved. Accordingly, folding stability of the adhesive layer may be enhanced, and sufficient folding properties may be provided.

In example embodiments, the adhesive sheet 100 may further include a protective film formed on the surface of the adhesive layer 110.

For example, the adhesive sheet 110 may include a first protective film 120 and a second protective film 130 formed on bottom and top surfaces of the adhesive layer 110, respectively.

The terms such as “bottom surface”, “top surface”, etc., used in this application are used in a relative sense to distinguish positions of components and do not specify an absolute position.

The first protective film 120 may be provided as a base film for forming the adhesive layer 110. The second protective film 130 may be provided as a release film for attaching the adhesive layer 110 to an object.

In some embodiments, the first protective film 120 may also be provided as a release film. In this case, the adhesive sheet 100 may be provided as a double-sided adhesive sheet.

The first protective film 120 and the second protective film 130 may include, e.g., a polyester resin such as polyethylene terephthalate, polybutylene terephthalate, polyethylene naphthalate, polybutylene naphthalate, etc.; a polyimide resin; an acrylic resin; a styrene-based resin such as polystyrene and acrylonitrile-styrene; a polycarbonate resin; a polylactic acid resin; a polyurethane resin; a polyolefin resin such as polyethylene, polypropylene, an ethylene-propylene copolymer, etc.; a vinyl resin such as polyvinyl chloride, polyvinylidene chloride, etc.; a polyamide resin; a sulfone-based resin; a polyether-etherketone resin; an allylate-based resin, etc.

Hereinafter, experimental examples including specific examples and comparative examples are presented to enhance the understanding of the present invention, but this only exemplifies the present invention and does not limit the scope of the attached patent claims, and it is clear to those skilled in the art that various changes and modifications to embodiments can be made within the scope of the present invention and technical ideas, and it is obvious that these modifications and modifications are included in the range of to the attached patent claims.

### Preparation Example: Preparation of Acrylic Copolymer

### Preparation Example 1

A monomer blend containing 90 parts by weight of 2-ethylhexylacrylate (2-EHA) and 10 parts by weight of 4-hydroxybutylacrylate (4-HBA) was charged into a 1 L reactor, and then 100 parts by weight of ethyl acetate (EAc) was charged as a solvent. A nitrogen gas was purged for 1 hour to remove oxygen, and a temperature was maintained at 80° C. After uniformly mixing the monomer mixture, 0.1 parts by weight of azobisisobutyronitrile (AIBN) was charged as a reaction initiator, and the reaction was performed for 8 hours to prepare an acrylic copolymer (weight average molecular weight: 1 million).

### Preparation Examples 2 to 9

Acrylic copolymers were prepared by changing monomer components and contents (parts by weight) as shown in Table 1 below by the same method as that in Preparation Example 1.

TABLE 1

| | alkyl(meth)acrylate | | | | | polar monomer | | | |
|---|---|---|---|---|---|---|---|---|---|
| | | | | | less than | carboxyl | hydroxyl | | molecular |
| | the carbon number of 8 or more | | | | 8 | group | group | | weight |
| | EHA | EHDG-AT | LA | SA | BA | AA | 2-HEA | 4-HBA | (*10⁴) |
| Preparation | 90 | — | — | — | — | — | — | 10 | 100 |
| Example 1 | | | | | | | | | |
| Preparation | 78 | 12 | — | — | — | — | 10 | — | 120 |
| Example 2 | | | | | | | | | |
| Preparation | 80.9 | 10 | — | — | — | 0.1 | — | 9 | 110 |
| Example 3 | | | | | | | | | |
| Preparation | 79 | 10 | — | — | — | 1 | — | 10 | 115 |
| Example 4 | | | | | | | | | |
| Preparation | 80 | — | 10 | — | — | — | — | 10 | 103 |
| Example 5 | | | | | | | | | |
| Preparation | 80 | — | — | 10 | — | — | — | 10 | 98 |
| Example 6 | | | | | | | | | |
| Preparation | — | — | — | — | 90 | — | — | 10 | 107 |
| Example 7 | | | | | | | | | |
| Preparation | 95 | — | — | — | — | 5 | — | — | 105 |
| Example 8 | | | | | | | | | |
| Preparation | 82.9 | 11 | — | — | 5 | 0.1 | — | 1 | 110 |
| Example 9 | | | | | | | | | |

The specific components listed in Table 1 are as follows.
EHA: 2-ethylhexyl acrylate (Sigma Aldrich)
EHDG-AT: 2-ethyl hexyl diglycol acrylate (Kyoeisha Chemical)
LA: lauryl acrylate (Kyoeisha Chemical)
SA: stearyl acrylate (Kyoeisha Chemical)
BA: butyl acrylate (Kyoeisha Chemical)
AA: acrylic acid (Sigma Aldrich)
2-HEA: 2-hydroxyethyl acrylate (Sigma Aldrich)
4-HBA: 4-hydroxybutyl acrylate (Sigma Aldrich)

### Experimental Example

Adhesive compositions according to Examples and Comparative Examples were prepared using the acrylic copolymers synthesized in Preparation Examples as shown in Tables 2 to 5. The adhesive composition was applied to a 75 μm-thick release film coated with a silicone release agent to a thickness of 50 μm, dried at 110° C. for 5 minutes, and a release film was laminated to form an adhesive sheet.

### 1) Measurement of Recovery Ratio

The 50 μm-thick adhesive sheets of Examples and Comparative Examples were laminated 20 times to a thickness of 1,000 μm, and a creep strain and a recovery strain were measured at 25° C. using a measuring device (MCR-301, Anton Paar). The conditions of the measuring device are as follows.

Thereafter, the measured creep strain and recovery strain were substituted into the above-described Equation 1 to calculate the recovery ratio.
Test temperature: 25° C.
Shear stress: 10,000 Pa
Creep time: 600 seconds
Recovery time: 600 seconds

### 2) Evaluation of Adhesive Force

Each adhesive sheet of Examples and Comparative examples was cut to a size of 25 mm×100 mm, the release film was peeled off, and an adhesive surface was subjected to a corona treatment or a plasma treatment, and then laminated on a glass substrate and autoclaved to prepare a specimen. An adhesive force was measured by maintaining the prepared specimen at 23° C., 50% RH for 24 hours, and then peeling the adhesive layer using a universal tensile tester (UTM, Instron) at a peeling rate of 300 mm/min and a peeling angle of 180°. The measurement was performed under the conditions of 23° C., 50% RH.

### <Evaluation Criteria>

⊚: 25N/25 mm or more
∘: 20N/25 mm or more and less than 25N/25 mm
x: less than 20N/25 mm

### 3) Evaluation on Folding Property

The adhesive sheets of Examples and Comparative Examples were adhered to PET having a thickness of 50 μm to prepare a 20 mm×100 mm sample. The sample was fixed to a folding evaluation device (COVOTECH, CFT-720C), and the folding evaluation was performed at −30° C. under the conditions of 25 folds per minute with a radius of curvature of 2 mm and holding for 0.2 seconds after one fold. The folding property was evaluated by measuring the number of folding cycles at which defects such as breakage, lifting and peeling occurred at a folded portion.

### <Evaluation Criteria>

⊚: No defects occurred when folding more than 50,000 times or more
∘: Defects occurred in a range of 20,000 to 50,000 folding cycles
x: Defects occurred when folding less than 20,000 times

The evaluation results are shown in Tables 2 to 5 below. Specific components used in Tables 2 to 5 are as follows.
organometallic compound A: diisopropoxyzirconium bisacetylacetonate
organometallic compound B: isopropoxyaluminum bisacetylacetonate
organometallic compound C: diisopropoxyaluminum monostearylacetoacetate
isocyanate compound D: D-103 (Mitsui Chemical)
isocyanate compound E: D-110N (Mitsui Chemical)
cross-linking retarder F: acetyl acetone

TABLE 2

| | | | Example | Example | Example | Example | Example | Example |
|---|---|---|---|---|---|---|---|---|
| category | | | 1 | 2 | 3 | 4 | 5 | 6 |
| adhesive | copolymer | type | Preparation | Preparation | Preparation | Preparation | Preparation | Preparation |
| composition | | | Example 1 | Example 1 | Example 1 | Example 2 | Example 3 | Example 4 |
| | | parts | 100 | 100 | 100 | 100 | 100 | 100 |
| | | by | | | | | | |
| | | weight | | | | | | |
| | organo- | A | 0.3 | — | — | — | — | — |
| | metallic | B | — | 0.3 | — | 0.3 | 0.3 | 0.3 |
| | compound | C | — | — | 0.3 | — | — | — |
| | isocyanate | D | 0.05 | 0.05 | 0.05 | 0.05 | 0.05 | — |
| | compound | E | — | — | — | — | — | 0.05 |
| | cross-linking | F | 0.5 | 0.5 | 0.5 | 0.5 | 0.5 | 0.5 |
| | retarder | | | | | | | |

| | | | | | | |
|---|---|---|---|---|---|---|
| recovery ratio(%) | 91.1 | 90.8 | 92.2 | 84.7 | 85.6 | 84.3 |
| adhesive force | ◯ | ⊚ | ◯ | ⊚ | ◯ | ◯ |
| folding property | ⊚ | ⊚ | ⊚ | ◯ | ⊚ | ◯ |

TABLE 3

| | | | Example | Example | Example | Example | Example | Example |
|---|---|---|---|---|---|---|---|---|
| category | | | 7 | 8 | 9 | 10 | 11 | 12 |
| adhesive | copolymer | type | Preparation | Preparation | Preparation | Preparation | Preparation | Preparation |
| composition | | | Example 4 | Example 4 | Example 5 | Example 6 | Example 1 | Example 1 |
| | | parts | 100 | 100 | 100 | 100 | 100 | 100 |
| | | by | | | | | | |
| | | weight | | | | | | |
| | organo- | A | — | — | — | — | 0.3 | — |
| | metallic | B | — | — | — | — | — | — |
| | compound | C | 0.3 | 0.3 | 0.3 | 0.3 | — | 0.3 |
| | isocyanate | D | 0.05 | — | — | — | 0.03 | 0.03 |
| | compound | E | — | 0.05 | 0.05 | 0.05 | — | — |
| | cross-linking | F | 0.5 | 0.5 | 0.5 | 0.5 | 0.5 | 0.5 |
| | retarder | | | | | | | |

| | | | | | | |
|---|---|---|---|---|---|---|
| recovery ratio(%) | 81.2 | 82.4 | 89.7 | 88.5 | 92.3 | 93.2 |
| adhesive force | ⊚ | ⊚ | ◯ | ◯ | ⊚ | ⊚ |
| folding property | ◯ | ◯ | ⊚ | ⊚ | ⊚ | ⊚ |

TABLE 4

| category | | | Example 13 | Example 14 | Example 15 |
|---|---|---|---|---|---|
| adhesive | copolymer | type | Preparation | Preparation | Preparation |
| composition | | | Example 4 | Example 4 | Example 1 |
| | | Parts by | 100 | 100 | 100 |
| | | weight | | | |
| | organo- | A | — | — | 0.3 |
| | metallic | B | 0.3 | — | — |
| | compound | C | — | 0.3 | — |
| | isocyanate | D | — | — | 0.02 |
| | compound | E | 0.03 | 0.03 | — |
| | cross-linking | F | 0.5 | 0.5 | 0.5 |
| | retarder | | | | |

| | | | |
|---|---|---|---|
| recovery ratio(%) | 86.2 | 85.1 | 93.2 |
| adhesive force | ◯ | ⊚ | ⊚ |
| folding property | ⊚ | ⊚ | ⊚ |

TABLE 5

| | | | Comparative | Comparative | Comparative | Comparative |
|---|---|---|---|---|---|---|
| category | | | Example 1 | Example 2 | Example 3 | Example 4 |
| adhesive | copolymer | type | Preparation | Preparation | Preparation | Preparation |
| composition | | | Example 1 | Example 7 | Example 8 | Example 9 |
| | | parts | 100 | 100 | 100 | 100 |
| | | by | | | | |
| | | weight | | | | |
| | organo- | A | — | — | — | — |
| | metallic | B | — | 0.3 | 0.3 | 0.3 |
| | compound | C | — | — | — | — |
| | isocyanate | D | — | 0.05 | 0.05 | 0.05 |
| | compound | E | — | — | — | — |
| | cross- | F | 0.5 | 0.5 | 0.5 | 0.5 |
| | linking | | | | | |
| | retarder | | | | | |

| | | | | |
|---|---|---|---|---|
| recovery ratio(%) | 45.2 | 52.6 | 62.5 | 65.1 |
| adhesive force | X | ⊚ | ⊚ | X |
| folding property | X | X | X | X |

Referring to Tables 1 to 4, the adhesive compositions according to Examples included the polymer of the acrylate having 8 or more carbon atoms and the hydroxyl group-containing polar monomer, the organometallic compound, and the isocyanate compound. Thus, the adhesive layer having high recovery ratio and adhesive force was provided.

In Examples 1 to 3 where only 2-ethylhexylacrylate was used as the acrylate monomer having 8 or more carbon atoms, the recovery ratio was increased to 90% or more, and the folding property was improved.

In Examples 5 to 8 where both the carboxyl group-containing monomer and the hydroxyl group-containing monomer were included as the polar monomers in the adhesive composition, the adhesive strength was enhanced.

In Examples 11 to 15 where the content of the isocyanate compound was in a range from 0.001 to 0.04 parts by weight based on 100 parts by weight of the acrylic copolymer, the recovery ratio, the adhesive strength and the folding property were all improved.

Referring to Table 5, in Comparative Example 1 where the organometallic compound and the isocyanate compound were not included, the recovery ratio was reduced, and the adhesive strength and the folding property were deteriorated.

In Comparative Example 2 where the acrylic copolymer in which the acrylate having 8 or more carbon atoms was not polymerized was used, the recovery ratio was reduced and the folding property was deteriorated.

In Comparative Example 3 where the acrylic copolymer in which the hydroxyl group-containing polar monomer was not polymerized was used, the recovery ratio was reduced and the folding property was deteriorated.

In Comparative Example 4 where the acrylic copolymer in which the hydroxyl group-containing polar monomer was polymerized in an amount of less than 3 wt % was used, the recovery ratio was reduced, and the adhesive strength and the folding property were deteriorated.

What is claimed is:

1. An adhesive composition comprising:
an acrylic copolymer comprising a polymer of a monomer blend that comprises 80 to 97 wt % of an alkyl(meth)acrylate monomer having an alkyl group having 8 or more carbon atoms, 3 to 20 wt % of a hydroxyl group-containing polar monomer, and 3 wt % or less of an acid group-containing polar monomer;
an organometallic compound; and
an isocyanate compound.

2. The adhesive composition according to claim 1, wherein the hydroxyl group-containing polar monomer comprises at least one of 2-hydroxyethyl (meth)acrylate, 2-hydroxypropyl (meth)acrylate, 4-hydroxybutyl (meth)acrylate, 2-hydroxybutyl (meth)acrylate, and hydroxyhexyl (meth)acrylate.

3. The adhesive composition according to claim 1, wherein the acid group-containing polar monomer comprises at least one of (meth)acrylic acid, carboxyethyl (meth)acrylate, and carboxypentyl (meth)acrylate.

4. The adhesive composition according to claim 1, wherein the organometallic compound comprises a metal chelate compound comprising at least one metal atom of titanium, zirconium, aluminum, zinc, iron and tin.

5. The adhesive composition according to claim 1, wherein a content of the organometallic compound is in a range from 0.1 to 2.0 parts by weight based on 100 parts by weight of the acrylic copolymer.

6. The adhesive composition according to claim 1, wherein the isocyanate compound is a polyfunctional isocyanate compound having two or more functional groups.

7. The adhesive composition according to claim 1, wherein a content of the isocyanate compound is 0.001 to 0.5 parts by weight based on 100 parts by weight of the acrylic copolymer.

8. The adhesive composition according to claim 7, wherein the content of the isocyanate compound is 0.001 parts by weight or more, and less than 0.05 parts by weight based on 100 parts by weight of the acrylic copolymer.

9. The adhesive composition according to claim 1, wherein the adhesive composition further comprises a cross-linking retarder.

10. The adhesive composition according to claim 9, wherein a content of the cross-linking retarder is in a range from 0.1 to 1.5 parts by weight based on 100 parts by weight of the acrylic copolymer.

11. An adhesive sheet comprising an adhesive layer including a cured product of the adhesive composition according to claim 1.

12. The adhesive sheet according to claim 11, wherein a recovery ratio defined by Equation 1 of the adhesive layer is 80% or more:
$$recovery ratio ( \% ) = ( 1 - \frac{A}{B} ) \times 100 \qquad [ Equation l ]$$
(In Equation 1, A is a creep strain measured after applying a shear stress of 10,000 Pa at 25° C. to a laminate in which 20 of the adhesive layers each having a thickness of 50 μm are stacked and maintaining for 600 seconds, and
B is a recovery strain measured after 600 seconds after removing the shear stress).

13. The adhesive sheet according to claim 12, wherein the recovery ratio of the adhesive layer is 85% or more.
